(19) United States
(12) Patent Application Publication
(10) Pub. No.: US 2024/0038213 A1
(43) Pub. Date: Feb. 1, 2024

(54) GENERATING METHOD, GENERATING DEVICE, AND GENERATING PROGRAM

(71) Applicant: NIPPON TELEGRAPH AND TELEPHONE CORPORATION, Tokyo (JP)

(72) Inventor: Hiroki KANAGAWA, Tokyo (JP)

(73) Assignee: NIPPON TELEGRAPH AND TELEPHONE CORPORATION, Tokyo (JP)

(21) Appl. No.: 18/038,702

(22) PCT Filed: Nov. 25, 2020
(86) PCT No.: PCT/JP2020/043852

§ 371 Date: May 24, 2023

(51) Int. Cl. G10L 13/047; G10L 13/06

(52) U.S. Cl. CPC G10L 13/047; G10L 13/06

(57) ABSTRACT

A generation device (100) extracts a plurality of integrated speech samples by repeatedly executing processing of integrating a plurality of consecutive speech samples included in speech waveform information into one speech sample, and generates a compressed speech sample by compressing the plurality of integrated speech samples extracted. The generation device (100) generates a plurality of new integrated speech samples subsequent to the plurality of integrated speech samples by inputting the compressed speech sample and an acoustic feature value calculated from the speech waveform information to a speech waveform generation model, and repeatedly executes processing of inputting a compressed speech sample obtained by compressing the plurality of new integrated speech samples and the acoustic feature value to the speech waveform generation model, to generate a plurality of new integrated speech samples a plurality of times.

### TECHNICAL FIELD

The present invention relates to a generation device, a generation method, and a generation program.

### BACKGROUND ART

In speech synthesis, a module that converts an acoustic feature value such as a spectrum or a pitch representing the height of voice into a speech waveform is called a vocoder. There are two major types of methods for implementing the vocoder.

One is a method based on signal processing, and methods such as STRAIGHT and WORLD are well-known (Non Patent Literatures 1 and 2). In this method, since conversion from the acoustic feature value to the speech waveform is expressed by a mathematical model, learning is unnecessary and processing speed is high, but quality of an analyzed and re-synthesized speech is inferior to that of a natural speech.

As another method, a method (neural vocoder) based on a neural network represented by WaveNet has been devised (Patent Literature 1). The neural vocoder is capable of synthesizing a speech having a quality comparable to that of a natural speech, but is slower in operation than a vocoder of signal processing because of a large amount of calculation. Normally, a forward propagation of the neural network needs to be performed once to predict one speech sample, so that it is difficult to perform real-time operation if the neural vocoder is implemented as it is.

To reduce the amount of calculation of the neural vocoder, and particularly to cause the neural vocoder to perform real-time operation in a central processing unit (CPU), two approaches are mainly adopted. One is to reduce a calculation cost per forward propagation of the neural network, and there are WaveRNN (Patent Literature 2) in which a huge convolutional neural network (CNN) used in WaveNet is replaced with a small-scale recurrent neural network (RNN), LPCNet (Non Patent Literature 3) in which linear prediction analysis (linear predictive coefficient (LPC)) that is knowledge of signal processing is utilized in a generation process for a speech waveform, and the like. The other is a method of reducing the number of times of forward propagation itself, and there is a method of simultaneously generating a plurality of speech samples (sound source signals serving as vibration parameters of vocal cords) by one forward propagation, for the sound source signals predicted by the above-described LPCNet (Non Patent Literature 4).

### CITATION LIST

### Patent Literature

Patent Literature 1: WO 2018/048934 A
Patent Literature 2: WO 2019/155054 A

### Non Patent Literature

Non Patent Literature 1: Hideki Kawahara, Ikuyo Masuda-Katsuse and Alain de Cheveigne, “Restructuring speech representations using a pitch-adaptive time frequency smoothing and an instantaneous-frequency-based FO extraction: Possible role of a repetitive structure in sounds,” Speech Communication, vol. 27, no. 3-4, pp. 187-207, 1999.
Non Patent Literature 2: Masanori Morise, Fumiya Yokomori, Kenji Ozawa, “WORLD: a vocoder-based high-quality speech synthesis system for real-time applications,” IEICE transactions on information and systems, vol. E99-D, no. 7, pp. 1877-1884, 2016.
Non Patent Literature 3: Jean-Marc Valin and Jan Skoglund, “LPCNET: Improving Neural Speech Synthesis through Linear Prediction,” Proc. ICASSP, 2019, pp. 5891-5895
Non Patent Literature 4: Vadim Popov, Mikhail Kudinov and Tasnima Sadekova, “Gaussian Lpcnet for Multisample Speech Synthesis,” Proc. ICASSP, 2020 pp. 6204-6208.

### SUMMARY OF INVENTION

### Technical Problem

Here, it is considered to generate a plurality of speech samples by one forward propagation. In Non Patent Literature 4, instead of directly predicting a speech sample, a plurality of sound source signals that are vibration parameters of vocal cords are generated by one forward propagation, and a speech waveform at the next time is generated by using an LPC coefficient that is information on vocal tract characteristics, and speeches of immediately preceding several samples.

That is, speech waveform generation by the LPC strongly depends on the information on the immediately preceding several samples, and even if accuracy of sound source signal generation by the neural network is somewhat low, the speech waveform can be generated without significant deterioration by the knowledge of the signal processing. However, due to that the generation process depends too much on the immediately preceding samples and that the height of the voice is determined by the fluctuation cycle of the speech sample, a speech having the height (pitch) of a voice that does not appear in learning data cannot be synthesized, and in the worst case, the speech waveform generation may fail.

On the other hand, in a method of directly predicting a speech waveform sample by a neural network, such as WaveRNN of Patent Literature 2, waveform generation does not fail even if the pitch is changed, and speech having a desired pitch to some extent can be synthesized. However, when it is tried to directly generate a plurality of speech samples by one forward propagation following Non Patent Literature 3, many discontinuous samples are generated as compared with a case where prediction is performed for each sample, and there is no assistance by knowledge of a generation process for a signal, so that the quality is greatly deteriorated.

The present invention has been made in view of the above, and an object of the present invention is to provide a generation method, a generation device, and a generation program capable of generating a plurality of speech samples with less discontinuous feeling in one forward propagation.

### Solution to Problem

To solve the above-described problems and achieve the object, a generation method according to the present invention includes: a compression step of extracting a plurality of integrated speech samples by repeatedly executing processing of integrating a plurality of consecutive speech samples included in speech waveform information into one speech sample, and generating a compressed speech sample by compressing the plurality of integrated speech samples extracted; and a generation step of generating a plurality of new integrated speech samples subsequent to the plurality of integrated speech samples by inputting the compressed speech sample and an acoustic feature value calculated from the speech waveform information to a speech waveform generation model, and repeatedly executing processing of inputting a compressed speech sample obtained by compressing the plurality of new integrated speech samples and the acoustic feature value to the speech waveform generation model, to generate a plurality of new integrated speech samples a plurality of times.

### Advantageous Effects of Invention

According to the present invention, it is possible to generate a plurality of speech samples with less discontinuous feeling by one forward propagation.

### BRIEF DESCRIPTION OF DRAWINGS

FIG. 1 is a functional block diagram illustrating a configuration of a generation device according to Example 1.

FIG. 2 is a diagram illustrating a configuration of a learning unit according to Example 1.

FIG. 3 is a diagram illustrating a configuration of a speech waveform generation unit according to Example 1.

FIG. 4 is a flowchart illustrating a processing procedure for the learning unit of the generation device according to Example 1.

FIG. 5 is a flowchart illustrating a processing procedure for the speech waveform generation unit of the generation device according to Example 1.

FIG. 6 is a functional block diagram illustrating a configuration of a generation device according to Example 2.

FIG. 7 is a diagram illustrating a configuration of a learning unit according to Example 2.

FIG. 8 is a diagram illustrating a configuration of a speech waveform generation unit according to Example 2.

FIG. 9 is a functional block diagram illustrating a configuration of a generation device according to Example 3.

FIG. 10 is a diagram illustrating a configuration of a learning unit according to Example 3.

FIG. 11 is a diagram illustrating a configuration of a speech waveform generation unit according to Example 3.

FIG. 12 is a diagram illustrating an example of a computer that executes a generation program.

### DESCRIPTION OF EMBODIMENTS

Hereinafter, examples of a generation method, a generation device, and a generation program disclosed in the present application will be described in detail with reference to the drawings. Note that the present invention is not limited by the examples.

### Example 1

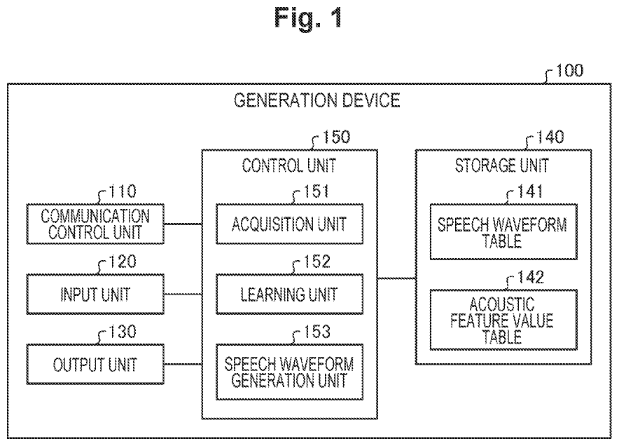

First, a configuration example of a generation device according to Example 1 will be described. FIG. 1 is a functional block diagram illustrating a configuration of the generation device according to Example 1. As illustrated in FIG. 1, a generation device 100 includes a communication control unit 110, an input unit 120, an output unit 130, a storage unit 140, and a control unit 150.

The communication control unit 110 is implemented by a network interface card (NIC) or the like, and controls communication between an external device and the control unit 150 via a telecommunication line such as a local area network (LAN) or the Internet.

The input unit 120 is implemented by using input devices such as a keyboard and a mouse, and inputs various kinds of instruction information such as a processing start to the control unit 150 in response to input operation of an operator.

The output unit 130 includes output devices that output information acquired from the control unit 150, and is implemented by a display device such as a liquid crystal display, a printing device such as a printer, and the like.

The storage unit 140 includes a speech waveform table 141 and an acoustic feature value table 142. The storage unit 140 is implemented by a semiconductor memory element such as a random access memory (RAM) or a flash memory, or a storage device such as a hard disk or an optical disk.

The speech waveform table 141 is a table that holds data of a speech waveform of each of utterances. Each speech waveform in the speech waveform table 141 is used at the time of learning a speech waveform generation model to be described later. The data of the speech waveform is data of a speech waveform data sampled at a predetermined sampling frequency.

The acoustic feature value table 142 is a table that holds data of a plurality of acoustic feature values. The acoustic feature values of the acoustic feature value table 142 are used when the data of the speech waveform is generated by using a learned speech waveform generation model.

The control unit 150 includes an acquisition unit 151, a learning unit 152, and a speech waveform generation unit 153. The control unit 150 corresponds to a CPU or the like.

The acquisition unit 151 acquires the data of the speech waveform table 141 and the data of the acoustic feature value table 142 via an external device (not illustrated) or the input unit 120. The acquisition unit 151 registers the data of the speech waveform table 141 and the data of the acoustic feature value table 142 in the storage unit 140.

The learning unit 152 executes learning (machine learning) of the speech waveform generation model on the basis of the speech waveform of the speech waveform table 141. The learning unit 152 corresponds to a compression unit and a generation unit.

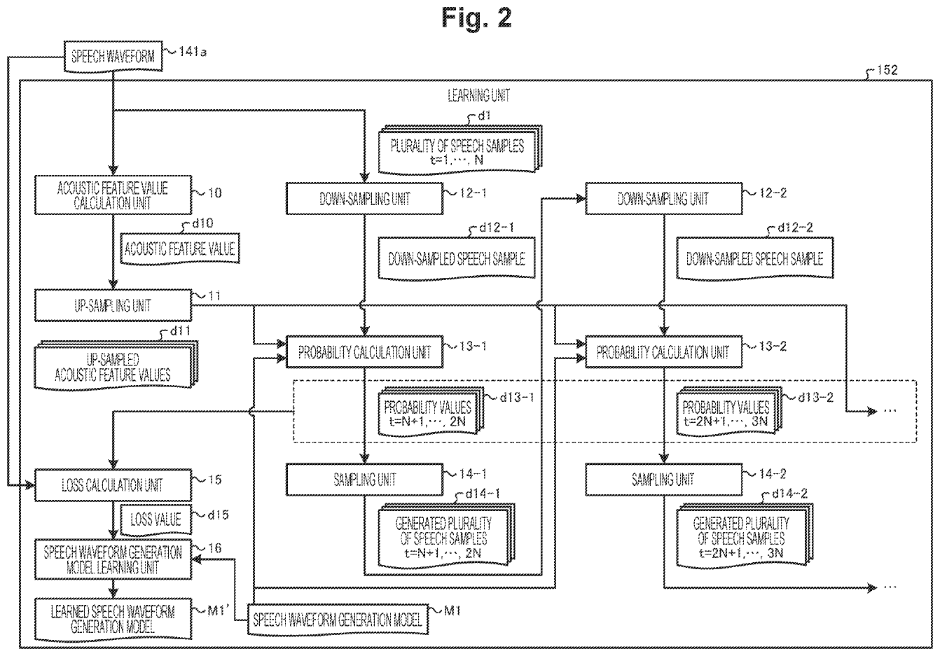

FIG. 2 is a diagram illustrating a configuration of a learning unit according to Example 1. As illustrated in FIG. 2, the learning unit 152 includes an acoustic feature value calculation unit 10, an up-sampling unit 11, down-sampling units 12-1, 12-2, . . . , probability calculation units 13-1, 13-2, . . . , sampling units 14-1, 14-2, . . . , a loss calculation unit 15, and a speech waveform generation model learning unit 16.

The learning unit 152 reads a speech waveform 141a from the speech waveform table 141 of FIG. 1. In addition, it is assumed that the learning unit 152 has information on a speech waveform generation model M1 at an initial stage.

Although not illustrated, the speech waveform generation model M1 may be stored in the storage unit 140.

The acoustic feature value calculation unit 10 calculates an acoustic feature value d10 on the basis of the speech waveform 141a. The acoustic feature value d10 corresponds to spectrum information such as mel cepstrum and prosody information such as a fundamental frequency and a pitch width. The acoustic feature value calculation unit 10 outputs the acoustic feature value d10 to the up-sampling unit 11.

The up-sampling unit 11 extends a sequence length of the acoustic feature value d10 so that the sequence length is the same as the number of speech samples, thereby generating up-sampled acoustic feature values d11. The up-sampling unit 11 outputs the acoustic feature values d11 to the probability calculation units 13-1, 13-2, . . . .

Here, in a case where a speech waveform with a sampling frequency of 22 kHz is predicted from one acoustic feature value d10 every 5 milliseconds normally, 110 (=2000×0.005) samples correspond to one acoustic feature value normally. In Example 1, since two speech samples are predicted by one forward propagation, the up-sampling unit 11 extends the acoustic feature value d10 so that 55 speech samples (speech samples of one frame) down-sampled by the down-sampling unit 12-1 correspond to one acoustic feature value d10.

The up-sampling unit 11 may perform extension by arranging vectors of the acoustic feature value d10 corresponding to the speech samples of one frame by the number of samples (55 samples). In addition, the up-sampling unit 11 may extend the acoustic feature value d10 by performing feature value conversion by using a one-dimensional CNN or a two-dimensional CNN in consideration of continuity of the preceding and subsequent frames by WaveRNN.

The down-sampling unit 12-1 repeatedly executes processing of integrating two consecutive speech samples from the speech waveform 141a into one speech sample, thereby acquiring a plurality of speech samples d1 at times t=1, . . . N. The plurality of speech samples d1 correspond to “integrated speech samples”. The symbol t is an index of time. For example, the down-sampling unit 12-1 performs integration by averaging or weighted averaging to two speech samples.

The down-sampling unit 12-1 executes down-sampling on the plurality of speech samples d1, thereby generating a down-sampled (compressed) speech sample d12-1. The down-sampling unit 12-1 executes down-sampling by averaging N samples of the plurality of speech samples d1. The down-sampling unit 12-1 may execute down-sampling by thinning out samples, or may execute down-sampling by using a low-pass filter.

The down-sampling unit 12-1 outputs the speech sample d12-1 to the probability calculation unit 13-1.

The probability calculation unit 13-1 inputs the acoustic feature values d11 and the speech sample d12-1 to the speech waveform generation model M1, thereby calculating probability values d13-1 (regarding the amplitude of the speech waveform) at times t=N+1, . . . , 2N. For example, assuming that the speech waveform is reduced to have lower bit depth in advance by the p-raw algorithm or the like, the probability values d13-1 are posterior probabilities of respective bits predicted by the speech waveform generation model M1. The speech waveform generation model M1 can also be configured to predict the mean and variance of a Gaussian distribution or a beta distribution, and parameters of a mixed logistic distribution in addition to a posterior probability of a bit value, and the probability values d13-1 at that time correspond to parameters generated from the speech waveform generation model M1.

The probability calculation unit 13-1 outputs the probability values d13-1 to the sampling unit 14-1 and the loss calculation unit 15.

The sampling unit 14-1 outputs values according to a specific distribution depending on the probability values d13-1, thereby generating a plurality of speech samples d14-1 at the times t=N+1, . . . 2N. In the case of predicting a bit of the speech waveform, the sampling unit 14-1 generates one sample from a categorical distribution. The sampling unit 14-1 executes such operation on each of the N probability values d13-1, and simultaneously obtains N samples by one forward propagation.

In addition, the sampling unit 14-1 may generate the plurality of speech samples d14-1 by calculating an amplitude (bit value) of the speech waveform at the time t=N+1 on the basis of the probability value at time t=N+1 and repeatedly executing the above processing also on the probability values at the times t=N+2, . . . 2N.

The sampling unit 14-1 outputs the plurality of speech samples d14-1 to the down-sampling unit 12-2.

The down-sampling unit 12-2 executes down-sampling on the plurality of speech samples d14-1, thereby generating a down-sampled speech sample d12-2. The description of the down-sampling executed by the down-sampling unit 12-2 is similar to the description of the down-sampling executed by the down-sampling unit 12-1.

The down-sampling unit 12-2 outputs the speech sample d12-2 to the probability calculation unit 13-2.

The probability calculation unit 13-2 inputs the acoustic feature values d11 and the speech sample d12-2 to the speech waveform generation model M1, thereby calculating probability values d13-2 (regarding the amplitude of the speech waveform) at times t=2N+1, . . . , 3N. The description of the other calculation executed by the probability calculation unit 13-2 is similar to the description of the calculation executed by the probability calculation unit 13-1.

The probability calculation unit 13-2 outputs the probability values d13-2 to the sampling unit 14-2 and the loss calculation unit 15.

The sampling unit 14-2 outputs values according to a specific distribution depending on the probability values d13-2, thereby generating a plurality of speech samples d14-2 at the times t=2N+1, . . . 3N. The description of other processing executed by the sampling unit 14-2 is similar to the description of the processing executed by the sampling unit 14-1.

The sampling unit 14-2 outputs the plurality of speech samples d14-2 to the down-sampling unit 12-3 (not illustrated). Thereafter, the down-sampling units 12-3, the probability calculation units 13-3, . . . , and the sampling units 14-3, . . . (not illustrated) each execute processing, thereby generating probability values d13-3 to d13-M and a plurality of speech samples d14-3 to d14-M.

The loss calculation unit 15 calculates a loss value d15 on the basis of the probability values d13-1 to d13-M and the speech waveform 141a. Here, the loss indicates a value corresponding to an error between the true speech waveform (speech waveform 141a) and the value actually predicted by the speech waveform generation model M1. The probability values d13-1 to d13-M are collectively referred to as “probability values d13”.

In a case where the loss value is calculated by using the probability values output from the speech waveform generation model M1 as in Example 1, the loss calculation unit 15 calculates cross entropy based on the probability values d13 and the speech waveform 141a as the loss value d15. In addition, in a case where a speech sample is generated in accordance with a Gaussian distribution, a beta distribution, or the like, a negative log likelihood can be used as the loss value. The loss calculation unit 15 outputs the loss value d15 to the speech waveform generation model learning unit 16.

The speech waveform generation model learning unit 16 receives inputs of the speech waveform generation model M1 and the loss value d15, and updates parameters of the speech waveform generation model M1 so that the loss value d15 decreases. For example, the speech waveform generation model learning unit 16 updates the parameters of the speech waveform generation model M1 on the basis of the back error propagation algorithm.

The learning unit 152 acquires the speech waveform of the next utterance from the speech waveform table 141, and each time, the loss calculation unit 15 repeatedly calculates the loss value d15, and the speech waveform generation model learning unit 16 receives the inputs of the speech waveform generation model M1 and the loss value d15 and repeats processing of updating the parameters of the speech waveform generation model M1 so that the loss value d15 decreases, thereby generating a learned speech waveform generation model M1′.

It is assumed that, in a case where the parameters of the speech waveform generation model M1 are updated with the loss value d15 based on the speech waveform 141a regarding the current utterance, and the probability value regarding the speech waveform regarding the next utterance is calculated, the probability calculation units 13-1, 13-2, . . . calculate the probability values d13 by using the speech waveform generation model M1′ updated with the loss value d15.

Each processing unit included in the learning unit 152 learns the speech waveform generation model M1 by repeatedly executing the above processing on the speech waveform of each utterance included in the speech waveform table 141. In the following description, the learned speech waveform generation model M1 is referred to as a “speech waveform generation model M2”.

The description of FIG. 1 will be made. The speech waveform generation unit 153 generates a speech waveform by inputting the acoustic feature value of the acoustic feature value table 142 to the speech waveform generation model M2.

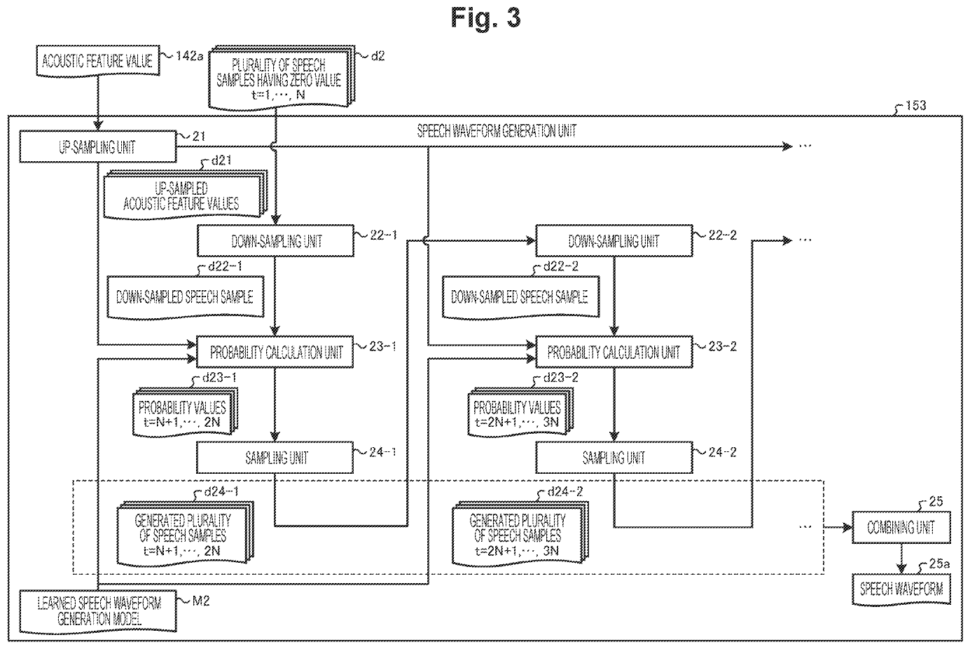

FIG. 3 is a diagram illustrating a configuration of a speech waveform generation unit according to Example 1. As illustrated in FIG. 3, the speech waveform generation unit 153 includes an up-sampling unit 21, down-sampling units 22-1, 22-2, . . . , probability calculation units 23-1, 23-2, . . . , sampling units 24-1, 24-2, . . . , and a combining unit 25.

The speech waveform generation unit 153 reads an acoustic feature value 142a from the acoustic feature value table 142 in FIG. 1. In addition, it is assumed that the speech waveform generation unit 153 has information on the speech waveform generation model M2 learned by the learning unit 152. In addition, it is assumed that the speech waveform generation unit 153 has a plurality of speech samples d2 having a zero value. The plurality of speech samples d2 having a zero value is a speech sample in which the values of the speech waveform corresponding to the times t=1, . . . N are all zero.

The up-sampling unit 21 extends a sequence length of the acoustic feature value 142a so that the sequence length is the same as the number of speech samples, thereby generating up-sampled acoustic feature values d21. The up-sampling unit 11 outputs the acoustic feature values d21 to the probability calculation units 23-1, 23-2, . . . . The up-sampling executed by the up-sampling unit 21 is similar to the up-sampling executed by the up-sampling unit 11 described above.

The down-sampling unit 22-1 executes down-sampling on the plurality of speech samples d2, thereby generating a down-sampled speech sample d22-1. The down-sampling unit 22-1 outputs the speech sample d22-1 to the probability calculation unit 23-1. The down-sampling executed by the down-sampling unit is similar to the down-sampling executed by the down-sampling unit 12-1 described above.

The probability calculation unit 23-1 inputs the acoustic feature values d21 and the speech sample d22-1 to the speech waveform generation model M2, thereby calculating probability values d23-1 (regarding the amplitude of the speech waveform) at the times t=N+1, . . . , 2N. The probability calculation unit 23-1 outputs the probability values d23-1 to the sampling unit 24-1. The description of the other calculation executed by the probability calculation unit 23-1 is similar to the description of the calculation executed by the probability calculation unit 13-1 and the like.

The sampling unit 24-1 outputs values according to a specific distribution depending on the probability values d23-1, thereby generating a plurality of speech samples d24-1 at the times t=2N+1, . . . 3N. The sampling unit 24-1 outputs the plurality of speech samples d24-1 to the down-sampling unit 22-2. The description of other processing executed by the sampling unit 24-2 is similar to the description of the processing executed by the sampling unit 14-1.

The down-sampling unit 22-2 executes down-sampling on the plurality of speech samples d24-1, thereby generating a down-sampled speech sample d22-2. The down-sampling unit 22-2 outputs the speech sample d22-2 to the probability calculation unit 23-2. The down-sampling executed by the down-sampling unit is similar to the down-sampling executed by the down-sampling unit 12-1 described above.

The probability calculation unit 23-2 inputs the acoustic feature values d21 and the speech sample d22-2 to the speech waveform generation model M2, thereby calculating a probability value d23-2 (related to the amplitude of the speech waveform) at the times t=2N+1, . . . 3N. The probability calculation unit 23-2 outputs the probability values d23-2 to the sampling unit 24-2. The description of the other calculation executed by the probability calculation unit 23-2 is similar to the description of the calculation executed by the probability calculation unit 13-1 and the like.

The sampling unit 24-2 outputs the plurality of speech samples d24-2 to the down-sampling unit 22-3 (not illustrated). Thereafter, the down-sampling units 22-3, . . . , the probability calculation units 23-3, . . . , and the sampling units 24-3, . . . (not illustrated) each execute processing, thereby generating probability values d23-3 to d23-M and a plurality of speech samples d24-3 to d24-M.

The combining unit 25 generates a speech waveform 25a by connecting the plurality of speech samples d24-1 to d24-M together.

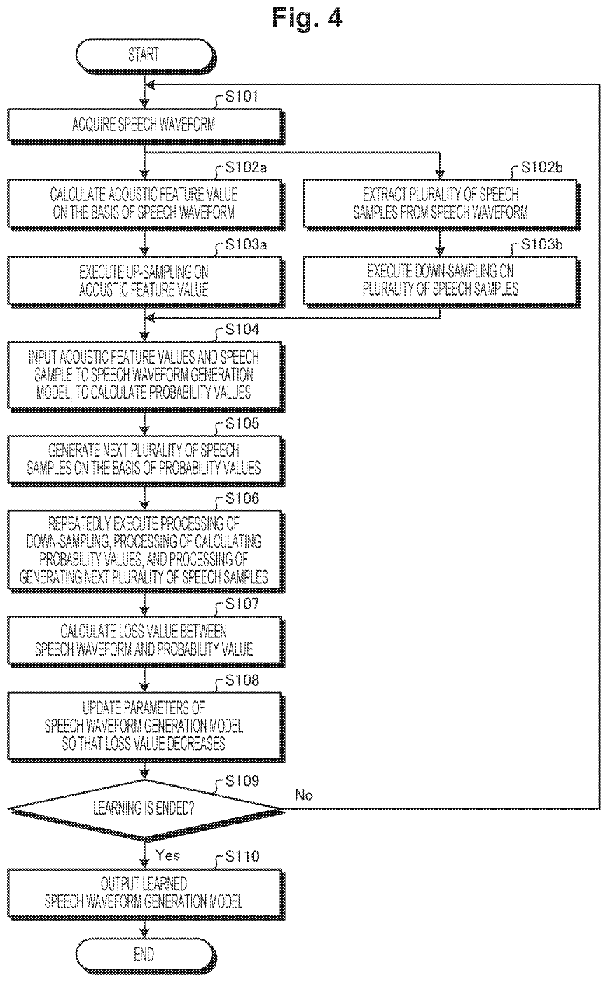

Next, an example of a processing procedure for the learning unit 152 of the generation device 100 according to Example 1 will be described. FIG. 4 is a flowchart illustrating a processing procedure for the learning unit of the generation device according to Example 1. As illustrated in FIG. 4, the learning unit 152 acquires a speech waveform from the speech waveform table 141 (step S101).

The acoustic feature value calculation unit 10 of the learning unit 152 calculates an acoustic feature value on the basis of the speech waveform (step S102a). The up-sampling unit 11 of the learning unit 152 executes up-sampling on the basis of the acoustic feature value (step S103a).

In addition, the down-sampling unit 12-1 of the learning unit 152 extracts a plurality of speech samples from the acoustic waveform (step S102b). The down-sampling unit 12-1 executes down-sampling on the plurality of speech samples (step S103b).

The probability calculation unit 13-1 of the learning unit 152 inputs the acoustic feature values d11 and the speech sample d12-1 to the speech waveform generation model M1, to calculate the probability values d13-1 (step S104). The sampling unit 14-1 of the learning unit 152 generates the next plurality of speech samples d14-1 on the basis of the probability values d13-1 (step S105).

The down-sampling units 12-2 to 12-M, the probability calculation units 13-2 to 13-M, and the sampling units 14-2 to 14-M of the learning unit 152 repeatedly execute processing of down-sampling, processing of calculating the probability values, and processing of generating the next plurality of speech samples (step S106).

The loss calculation unit 15 of the learning unit 152 calculates the loss value d15 between the speech waveform and the probability value (step S107). The speech waveform generation model learning unit 16 updates the parameters of the speech waveform generation model M1′ so that the loss value d15 decreases (step S108).

In a case where the learning is not ended (step S109, No), the learning unit 152 proceeds to step S101. In a case where the learning is ended (step S109, Yes), the learning unit 152 outputs the learned speech waveform generation model M2 to the speech waveform generation unit 153 (step S110).

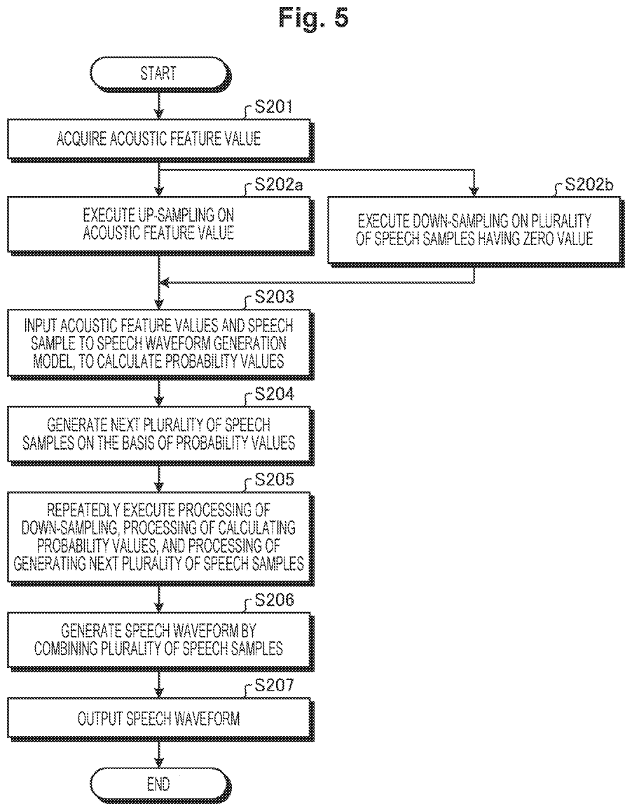

Next, an example of a processing procedure for the speech waveform generation unit 153 of the generation device 100 according to Example 1 will be described. FIG. 5 is a flowchart illustrating a processing procedure for the speech waveform generation unit of the generation device according to Example 1. As illustrated in FIG. 5, the speech waveform generation unit 153 acquires an acoustic feature value from the acoustic feature value table 142 (step S201).

The up-sampling unit 21 of the speech waveform generation unit 153 executes up-sampling on the basis of the acoustic feature value (step S202a). In addition, the down-sampling unit 22-1 of the speech waveform generation unit 153 executes down-sampling on a plurality of speech samples having a zero value (step S202b).

The probability calculation unit 23-1 of the speech waveform generation unit 153 inputs the acoustic feature values d21 and the speech sample d22-1 to the speech waveform generation model M2 to calculate the probability values d23-1 (step S203). The sampling unit 24-1 of the speech waveform generation unit 153 generates the next plurality of speech samples on the basis of the probability values (step S204).

The down-sampling units 22-2 to 22-M, the probability calculation units 23-2 to 23-M, and the sampling units 24-2 to 24-M of the speech waveform generation unit 153 repeatedly execute processing of down-sampling, processing of calculating the probability values, and processing of generating the next plurality of speech samples (step S205).

The combining unit 25 of the speech waveform generation unit 153 generate the speech waveform 25a by combining the plurality of speech samples (step S206). The combining unit 25 outputs the speech waveform 25a (step S207).

Next, effects of the generation device 100 according to Example 1 will be described. The learning unit 152 of the generation device 100 repeatedly executes processing of generating the next plurality of speech samples by inputting a speech sample d12 obtained by compressing the plurality of speech samples d1 and the up-sampled acoustic feature values to the speech waveform generation model M1. In this way, by performing information compression of the N previous speech samples into one sample, discontinuous feeling of the speech can be reduced.

The learning unit 152 generates the next plurality of speech samples on the basis of the probability values regarding the speech waveform at respective times output from the speech waveform generation model M1. As a result, it is possible to generate the next plurality of speech samples while improving the inference speed.

The learning unit 152 learns the speech waveform generation model on the basis of the loss value d15 between the probability value and the speech waveform. As a result, it is possible to appropriately learn the speech waveform generation model while improving the inference speed.

The speech waveform generation unit 153 of the generation device 100 repeatedly executes processing of generating a plurality of speech samples by inputting the acoustic feature values d21 obtained by up-sampling the acoustic feature value 142a and a speech sample obtained by down-sampling a plurality of speech samples to the learned speech waveform generation model M2, and generates the speech waveform by connecting the plurality of speech samples together. As a result, it is possible to appropriately generate the speech waveform corresponding to the acoustic feature value d142.

### Example 2

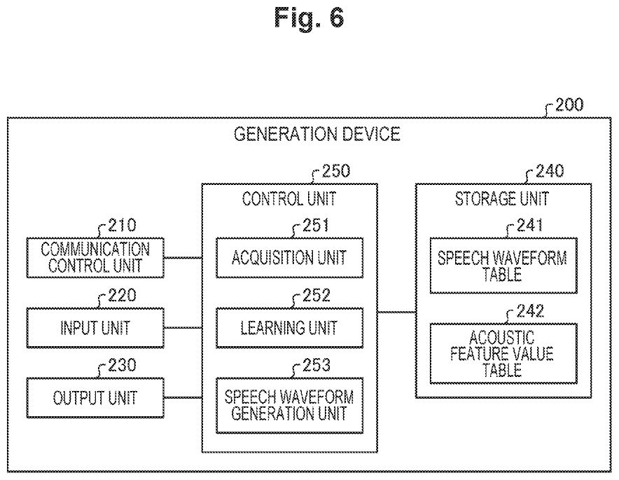

Next, a configuration example of a generation device according to Example 2 will be described. FIG. 6 is a functional block diagram illustrating a configuration of a generation device according to Example 2. As illustrated in FIG. 6, a generation device 200 includes a communication control unit 210, an input unit 220, an output unit 230, a storage unit 240, and a control unit 250.

The description regarding the communication control unit 210, the input unit 220, and the output unit 230 is similar to the description regarding the communication control unit 110, the input unit 120, and the output unit 130 described in FIG. 1.

The storage unit 240 includes a speech waveform table 241 and an acoustic feature value table 242. The storage unit 240 is implemented by a semiconductor memory element such as a RAM or a flash memory, or a storage device such as a hard disk or an optical disk.

The description regarding the speech waveform table 241 and the acoustic feature value table 242 is similar to the description regarding the speech waveform table 141 and the acoustic feature value table 142 described in FIG. 1.

The control unit 250 includes an acquisition unit 251, a learning unit 252, and a speech waveform generation unit 253. The control unit 250 corresponds to a CPU or the like.

The acquisition unit 251 acquires the data of the speech waveform table 241 and the data of the acoustic feature value table 242 via an external device (not illustrated) or the input unit 220. The acquisition unit 251 registers the data of the speech waveform table 241 and the data of the acoustic feature value table 242 in the storage unit 240.

The learning unit 252 executes learning (machine learning) of the speech waveform generation model on the basis of the speech waveform of the speech waveform table 241.

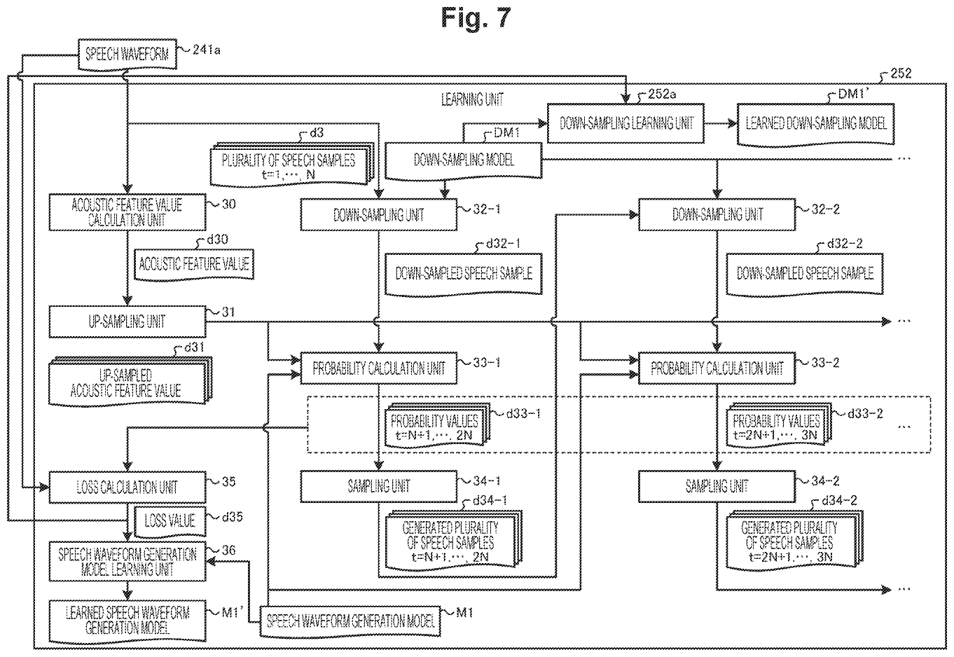

FIG. 7 is a diagram illustrating a configuration of a learning unit according to Example 2. As illustrated in FIG. 7, the learning unit 252 includes an acoustic feature value calculation unit 30, an up-sampling unit 31, down-sampling units 32-1, 32-2, . . . , probability calculation units 33-1, 33-2, . . . , sampling units 34-1, 34-2, . . . , a loss calculation unit 35, and a speech waveform generation model learning unit 36. In addition, the learning unit 252 includes a down-sampling learning unit 252a.

The learning unit 252 reads a speech waveform 241a from the speech waveform table 241 of FIG. 6. In addition, it is assumed that the learning unit 252 has information on a speech waveform generation model M1 and a down-sampling model DM1 at initial stages. Although not illustrated, the speech waveform generation model M1 and the down-sampling model DM1 may be stored in the storage unit 240.

The acoustic feature value calculation unit 30 calculates an acoustic feature value d30 on the basis of the speech waveform 241a. The acoustic feature value d30 corresponds to spectrum information such as mel cepstrum and prosody information such as a fundamental frequency and a pitch width. The acoustic feature value calculation unit 30 outputs the acoustic feature value d30 to the up-sampling unit 31.

The up-sampling unit 31 extends a sequence length of the acoustic feature value d30 so that the sequence length is the same as the number of speech samples, thereby generating up-sampled acoustic feature values d31. The up-sampling unit 31 outputs the acoustic feature value d31 to the probability calculation units 33-1, 33-2, . . . . Other descriptions regarding the up-sampling unit 31 are similar to those of the up-sampling unit 11 described in Example 1.

The down-sampling unit 32-1 repeatedly executes processing of integrating two consecutive speech samples from the speech waveform 241a into one speech sample, thereby acquiring a plurality of speech samples d3 at times t=1, . . . N. The plurality of speech samples d3 correspond to “integrated speech samples”.

The down-sampling unit 32-1 inputs the plurality of speech samples d3 to the down-sampling model DM1, thereby generating a down-sampled speech sample d32-1. The down-sampling model DM1 is a model that converts a plurality of speech samples into down-sampled speech samples, and is implemented by a DNN or the like.

The down-sampling unit 32-1 outputs the speech sample d32-1 to the probability calculation unit 33-1.

The probability calculation unit 33-1 inputs the acoustic feature values d31 and the speech sample d32-1 to the speech waveform generation model M1, thereby calculating probability values d33-1 (regarding the amplitude of the speech waveform) at times t=N+1, . . . , 2N. The probability calculation unit 33-1 outputs the probability values d33-1 to the sampling unit 34-1 and the loss calculation unit 35. Other descriptions of the probability calculation unit 33-1 are similar to those of the probability calculation unit 13-1 described in Example 1.

The sampling unit 34-1 outputs values according to a specific distribution depending on the probability values d33-1, thereby generating a plurality of speech samples d34-1 at the times t=N+1, . . . 2N. The sampling unit 34-1 outputs the plurality of speech samples d34-1 to the down-sampling unit 32-2.

The down-sampling unit 32-2 inputs the plurality of speech samples d34-1 to the down-sampling model DM1, thereby generating a down-sampled speech sample d32-2. The down-sampling unit 32-2 outputs the speech sample d32-2 to the probability calculation unit 33-2. Other processing executed by the down-sampling unit 32-2 is similar to the description of the down-sampling executed by the down-sampling unit 12-2.

The probability calculation unit 33-2 inputs the acoustic feature values d31 and the speech sample d32-2 to the speech waveform generation model M1, thereby calculating probability values d33-2 (regarding the amplitude of the speech waveform) at times t=2N+1, . . . , 3N. The probability calculation unit 33-2 outputs the probability values d33-2 to the sampling unit 34-2 and the loss calculation unit 35. Other processing regarding the probability calculation unit 33-2 is similar to the processing executed by the probability calculation unit 13-2.

The sampling unit 34-2 outputs values according to a specific distribution depending on the probability values d33-2, thereby generating a plurality of speech samples d34-2 at the times t=2N+1, . . . 3N. The description of other processing executed by the sampling unit 34-2 is similar to the description of processing executed by the sampling unit 14-2.

The sampling unit 34-2 outputs the plurality of speech samples d34-2 to the down-sampling unit 32-3 (not illustrated). Thereafter, the down-sampling units 32-3, . . . , the probability calculation units 33-3, . . . , and the sampling units 34-3, . . . (not illustrated) each execute processing, thereby generating probability values d33-3 to d33-M and a plurality of speech samples d34-3 to d34-M.

The loss calculation unit 35 calculates a loss value d35 on the basis of the probability values d33-1 to d33-M and the speech waveform 241a. Here, the loss indicates a value (loss value d35) corresponding to an error between the true speech waveform (speech waveform 241a) and the value actually predicted by the speech waveform generation model M1. The probability values d33-1 to d33-M are collectively referred to as “probability values d33”. The loss calculation unit 35 outputs the loss value d35 to the speech waveform generation model learning unit 36 and the down-sampling learning unit 252a. Other processing regarding the loss calculation unit 35 is similar to the processing executed by the loss calculation unit 15.

The speech waveform generation model learning unit 36 receives inputs of the speech waveform generation model M1 and the loss value d35, and updates the parameters of the speech waveform generation model M1 so that the loss value d35 decreases. For example, the speech waveform generation model learning unit 36 updates the parameters of the speech waveform generation model M1 on the basis of the back error propagation algorithm.

The down-sampling learning unit 252a receives inputs of the down-sampling model DM1 and the loss value d35, and updates the parameters of the down-sampling model DM1 so that the loss value d35 decreases. For example, the down-sampling learning unit 252a updates the parameters of the down-sampling model DM1 on the basis of the back error propagation algorithm.

The learning unit 252 acquires the speech waveform of the next utterance from the speech waveform table 241, and each time, the loss calculation unit 35 repeatedly calculates the loss value d35, and the down-sampling learning unit 252a receives the inputs of the down-sampling model DM1 and the loss value d35 and repeats processing of updating the parameters of the down-sampling model DM1 so that the loss value d35 decreases, thereby generating a down-sampling model DM1′.

It is assumed that, in a case where the parameters of the down-sampling model DM1 are updated with the loss value d35 based on the speech waveform 241a regarding the current utterance, and down-sampling of a plurality of speech samples regarding the speech waveform regarding the next utterance is executed, the down-sampling units 32-1, 32-2, . . . execute the down-sampling by using the down-sampling model DM1 updated with the loss value d35.

Each processing unit included in the learning unit 252 learns the speech waveform generation model M1 and the down-sampling model DM1 by repeatedly executing the above processing on the speech waveform of each utterance included in the speech waveform table 241. In the following description, the learned speech waveform generation model M1 is referred to as a “speech waveform generation model M2”. The learned down-sampling model DM1 is referred to as a “down-sampling model DM2”.

The description of FIG. 6 will be made. The speech waveform generation unit 253 generates a speech waveform by inputting the acoustic feature value of the acoustic feature value table 242 to the speech waveform generation model M2.

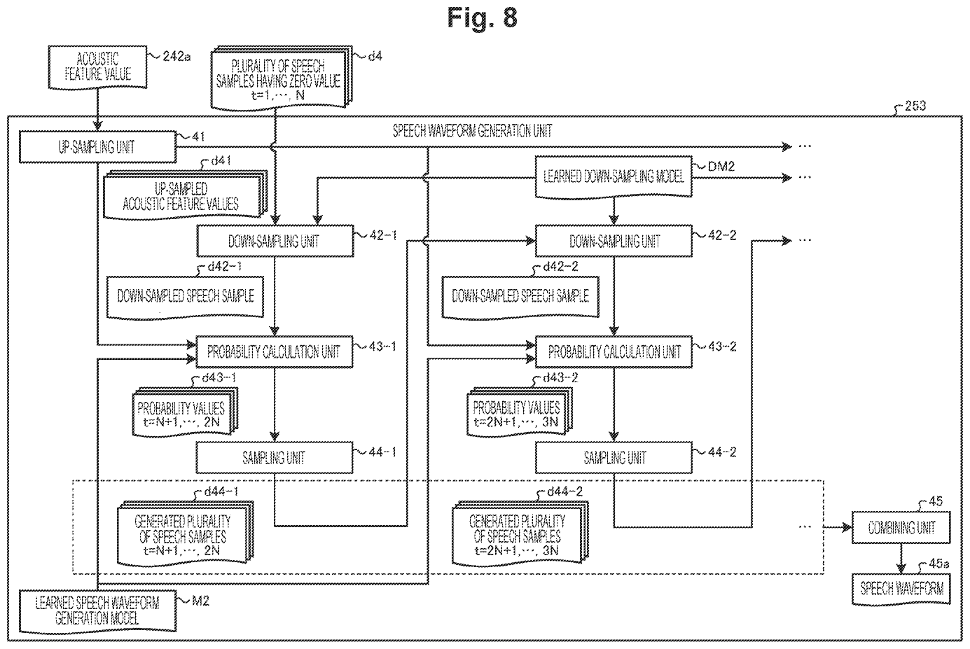

FIG. 8 is a diagram illustrating a configuration of a speech waveform generation unit according to Example 2. As illustrated in FIG. 8, the speech waveform generation unit 253 includes an up-sampling unit 41, down-sampling units 42-1, 42-2, . . . , probability calculation units 43-1, 43-2, . . . , sampling units 44-1, 44-2, . . . , and a combining unit 45.

The speech waveform generation unit 253 reads an acoustic feature value 242a from the acoustic feature value table 242 of FIG. 6. In addition, it is assumed that the speech waveform generation unit 253 has information on the speech waveform generation model M2 and information on the sampling model DM2 learned by the learning unit 252. In addition, it is assumed that the speech waveform generation unit 253 has a plurality of speech samples d4 having a zero value. The plurality of speech samples d4 having a zero value is a speech sample in which the values of the speech waveform corresponding to the times t=1, . . . N are all zero.

The up-sampling unit 41 extends a sequence length of the acoustic feature value 242a so that the sequence length is the same as the number of speech samples, thereby generating up-sampled acoustic feature values d21. The up-sampling unit 41 outputs the acoustic feature value d21 to the probability calculation units 23-1, 23-2, . . . . The up-sampling executed by the up-sampling unit 41 is similar to the up-sampling executed by the up-sampling unit 11 described above.

The down-sampling unit 42-1 inputs the plurality of speech samples d2 to the down-sampling model DM2, thereby generating a down-sampled speech sample d42-1. The down-sampling unit 42-1 outputs the speech sample d42-1 to the probability calculation unit 43-1. The down-sampling executed by the down-sampling unit is similar to the down-sampling executed by the down-sampling unit 32-1 described above.

The probability calculation unit 43-1 inputs the acoustic feature values d41 and the speech sample d42-1 to the speech waveform generation model M2, thereby calculating probability values d43-1 (regarding the amplitude of the speech waveform) at the times t=N+1, . . . , 2N. The probability calculation unit 43-1 outputs the probability values d43-1 to the sampling unit 44-1. The description of the other calculation executed by the probability calculation unit 43-1 is similar to the description of the calculation executed by the probability calculation unit 33-1 and the like.

The sampling unit 44-1 outputs values according to a specific distribution depending on the probability values d43-1, thereby generating a plurality of speech samples d44-1 at the times t=2N+1, . . . 3N. The sampling unit 44-1 outputs the plurality of speech samples d44-1 to the down-sampling unit 42-2. The description of other processing executed by the sampling unit 44-2 is similar to the description of the processing executed by the sampling unit 14-1.

The down-sampling unit 42-2 inputs the plurality of speech samples d44-1 to the down-sampling model DM2, thereby generating a down-sampled speech sample d42-2. The down-sampling unit 42-2 outputs the speech sample d42-2 to the probability calculation unit 43-2. The down-sampling executed by the down-sampling unit is similar to the down-sampling executed by the down-sampling unit 42-1 described above.

The probability calculation unit 43-2 inputs the acoustic feature values d41 and the speech sample d42-2 to the speech waveform generation model M2, thereby calculating probability values d43-2 (regarding the amplitude of the speech waveform) at the times t=2N+1, . . . , 3N. The probability calculation unit 43-2 outputs the probability values d43-2 to the sampling unit 44-2. The description of the other calculation executed by the probability calculation unit 43-2 is similar to the description of the calculation executed by the probability calculation unit 33-1.

The sampling unit 44-2 outputs the plurality of speech samples d44-2 to the down-sampling unit 42-3 (not illustrated). Thereafter, the down-sampling units 42-3, . . . , the probability calculation units 43-3, . . . , and the sampling units 44-3, . . . (not illustrated) each execute processing, thereby generating probability values d43-3 to d43-M and a plurality of speech samples d44-3 to d44-M.

The combining unit 45 generates a speech waveform 45a by connecting the plurality of speech samples d44-1 to d44-M together.

Next, effects of the generation device 200 according to Example 2 will be described. The learning unit 252 of the generation device 200 learns the down-sampling model DM1 so that the loss value d35 decreases. Then, the speech waveform generation unit 253 of the generation device 200 executes down-sampling by using the learned down-sampling model DM2. Regarding the generation speed, forward propagation processing for the down-sampling model DM2 increases, but is very light as compared with forward propagation of the speech waveform generation model M2.

For this reason, it is possible to generate a speech waveform while performing down-sampling to decrease the loss value d35 as compared with the generation device 100 of Example 1.

### Example 3

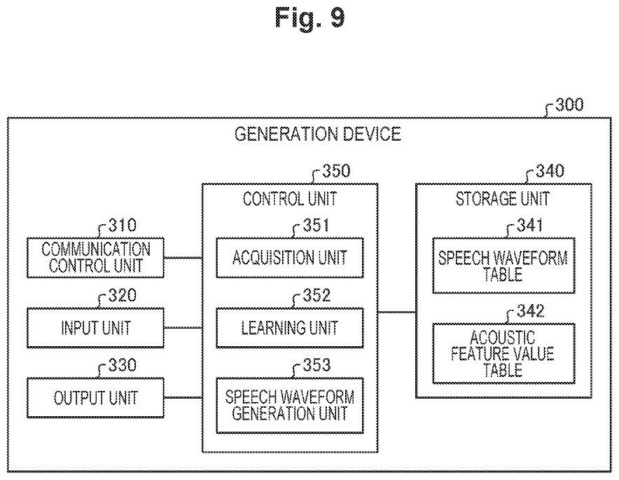

Next, a configuration example of a generation device according to Example 3 will be described. FIG. 9 is a functional block diagram illustrating a configuration of a generation device according to Example 3. As illustrated in FIG. 9, a generation device 300 includes a communication control unit 310, an input unit 320, an output unit 330, a storage unit 340, and a control unit 350.

The description regarding the communication control unit 310, the input unit 320, and the output unit 330 is similar to the description regarding the communication control unit 110, the input unit 120, and the output unit 130 described in FIG. 1.

The storage unit 340 includes a speech waveform table 341 and an acoustic feature value table 342. The storage unit 340 is implemented by a semiconductor memory element such as a RAM or a flash memory, or a storage device such as a hard disk or an optical disk.

The description regarding the speech waveform table 341 and the acoustic feature value table 342 is similar to the description regarding the speech waveform table 141 and the acoustic feature value table 142 described in FIG. 1.

The control unit 350 includes an acquisition unit 351, a learning unit 352, and a speech waveform generation unit 353. The control unit 350 corresponds to a CPU or the like.

The acquisition unit 351 acquires the data of the speech waveform table 341 and the data of the acoustic feature value table 342 via an external device (not illustrated) or the input unit 320. The acquisition unit 351 registers the data of the speech waveform table 341 and the data of the acoustic feature value table 342 in the storage unit 340.

The learning unit 352 executes learning (machine learning) of the speech waveform generation model on the basis of the speech waveform of the speech waveform table 341.

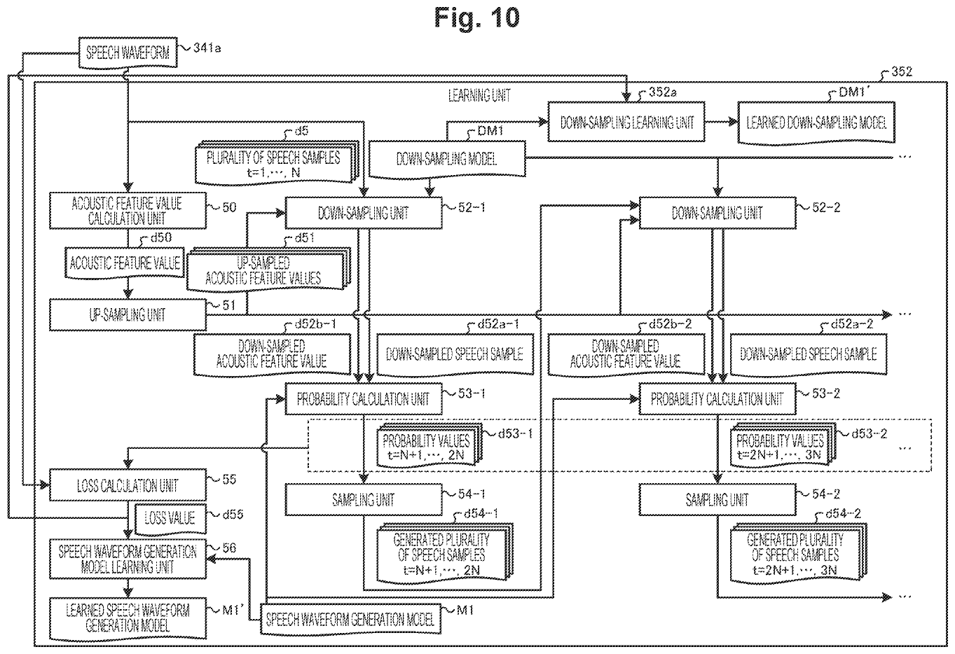

FIG. 10 is a diagram illustrating a configuration of a learning unit according to Example 3. As illustrated in FIG. 10, the learning unit 352 includes an acoustic feature value calculation unit 50, an up-sampling unit 51, down-sampling units 52-1, 52-2, . . . , probability calculation units 53-1, 53-2, . . . , sampling units 54-1, 54-2, . . . , a loss calculation unit 55, and a speech waveform generation model learning unit 56. In addition, the learning unit 352 includes a down-sampling learning unit 352a.

The learning unit 352 reads a speech waveform 341a from the speech waveform table 341 of FIG. 9. In addition, it is assumed that the learning unit 352 has information on a speech waveform generation model M1 and a down-sampling model DM1 at initial stages. Although not illustrated, the speech waveform generation model M1 and the down-sampling model DM1 may be stored in the storage unit 340.

The acoustic feature value calculation unit 50 calculates an acoustic feature value d50 on the basis of the speech waveform 341a. The acoustic feature value d50 corresponds to spectrum information such as mel cepstrum and prosody information such as a fundamental frequency and a pitch width. The acoustic feature value calculation unit 50 outputs the acoustic feature value d50 to the up-sampling unit 51.

The up-sampling unit 51 extends a sequence length of the acoustic feature value d50 so that the sequence length is the same as the number of speech samples, thereby generating up-sampled acoustic feature values d51. The up-sampling unit 51 outputs the acoustic feature values d51 to the down-sampling units 52-1, 52-2, . . . . Other descriptions of the up-sampling unit 51 are similar to those of the up-sampling unit 11 described in Example 1.

The down-sampling unit 52-1 repeatedly executes processing of integrating two consecutive speech samples from the speech waveform 241a into one speech sample, thereby acquiring a plurality of speech samples d5 at times t=1, . . . N. The plurality of speech samples d5 correspond to “integrated speech samples”.

The down-sampling unit 52-1 inputs the plurality of speech samples d3 and the acoustic feature values d51 to the down-sampling model DM1, thereby generating a down-sampled speech sample d52a-1 and a down-sampled acoustic feature value 52b-1. The down-sampling unit 52-1 outputs the speech sample d52a-1 and the acoustic feature value 52b-1 to the probability calculation unit 53-1.

The down-sampling model DM1 is a model that converts a plurality of speech samples and acoustic feature values into down-sampled speech samples and down-sampled acoustic feature values, and is implemented by a DNN or the like. For example, the down-sampling unit 52-1 performs dimension division of a vector between an acoustic feature value portion and a speech sample portion, thereby obtaining down-sampled speech samples and down-sampled acoustic feature values.

The probability calculation unit 53-1 inputs the acoustic feature value d52b-1 and the speech sample d52a-1 to the speech waveform generation model M1, thereby calculating probability values d53-1 (regarding the amplitude of the speech waveform) at times t=N+1, . . . , 2N. The probability calculation unit 53-1 outputs the probability values d53-1 to the sampling unit 54-1 and the loss calculation unit 55. Other descriptions of the probability calculation unit 53-1 are similar to those of the probability calculation unit 13-1 described in Example 1.

The sampling unit 54-1 outputs values according to a specific distribution depending on the probability values d53-1, thereby generating a plurality of speech samples d54-1 at the times t=N+1, . . . 2N. The sampling unit 54-1 outputs the plurality of speech samples d54-1 to the down-sampling unit 52-2.

The down-sampling unit 52-2 inputs the acoustic feature values d51 and the plurality of speech samples d54-1 to the down-sampling model DM1, thereby generating a down-sampled speech sample d52a-2 and a down-sampled acoustic feature value 52b-2. The down-sampling unit 52-2 outputs the speech sample d52a-2 and the acoustic feature value 52b-2 to the probability calculation unit 53-2.

The probability calculation unit 53-2 inputs the acoustic feature value 52b-2 and the speech sample 52a-2 to the speech waveform generation model M1, thereby calculating probability values d53-2 (regarding the amplitude of the speech waveform) at times t=2N+1, . . . 3N. The probability calculation unit 53-2 outputs the probability values d53-2 to the sampling unit 54-2 and the loss calculation unit 55. Other processing regarding the probability calculation unit 53-2 is similar to the processing executed by the probability calculation unit 13-2.

The sampling unit 54-2 outputs values according to a specific distribution depending on the probability values d53-2, thereby generating a plurality of speech samples d54-2 at the times t=2N+1, . . . 3N. The description of other processing executed by the sampling unit 54-2 is similar to the description of the processing executed by the sampling unit 14-2.

The sampling unit 54-2 outputs the plurality of speech samples d54-2 to the down-sampling unit 52-3 (not illustrated). Thereafter, the down-sampling units 52-3, . . . , the probability calculation units 53-3, . . . , and the sampling units 54-3, . . . (not illustrated) each execute processing, thereby generating probability values d53-3 to d53-M and a plurality of speech samples d54-3 to d54-M.

The loss calculation unit 55 calculates a loss value d55 on the basis of the probability values d53-1 to d53-M and the speech waveform 341a. Here, the loss indicates a value (loss value d55) corresponding to an error between the true speech waveform (speech waveform 341a) and the value actually predicted by the speech waveform generation model M1. The probability values d53-1 to d53-M are collectively referred to as “probability values d53”. The loss calculation unit 55 outputs the loss value d55 to the speech waveform generation model learning unit 56 and the down-sampling learning unit 352a. Other processing regarding the loss calculation unit 55 is similar to the processing executed by the loss calculation unit 15.

The speech waveform generation model learning unit 56 receives inputs of the speech waveform generation model M1 and the loss value d55, and updates the parameters of the speech waveform generation model M1 so that the loss value d55 decreases. For example, the speech waveform generation model learning unit 56 updates the parameters of the speech waveform generation model M1 on the basis of the back error propagation algorithm.

The down-sampling learning unit 352a receives inputs of the down-sampling model DM1 and the loss value d55, and updates the parameters of the down-sampling model DM1 so that the loss value d55 decreases. For example, the down-sampling learning unit 352a updates the parameters of the down-sampling model DM1 on the basis of the back error propagation algorithm.

The learning unit 352 acquires the speech waveform of the next utterance from the speech waveform table 341, and each time, the loss calculation unit 55 repeatedly calculates the loss value d55, and the down-sampling learning unit 352a receives the inputs of the down-sampling model DM1 and the loss value d55 and repeats processing of updating the parameters of the down-sampling model DM1 so that the loss value d55 decreases, thereby generating a down-sampling model DM1′.

It is assumed that, in a case where the parameters of the down-sampling model DM1 are updated with the loss value d55 based on the speech waveform 341a regarding the current utterance, and down-sampling of a plurality of speech samples regarding the speech waveform regarding the next utterance is executed, the down-sampling units 52-1, 52-2, . . . execute the down-sampling by using the down-sampling model DM1 updated with the loss value d55.

Each processing unit included in the learning unit 352 learns the speech waveform generation model M1 and the down-sampling model DM1 by repeatedly executing the above processing on the speech waveform of each utterance included in the speech waveform table 341. In the following description, the learned speech waveform generation model M1 is referred to as a “speech waveform generation model M2”. The learned down-sampling model DM1 is referred to as a “down-sampling model DM2”.

The description of FIG. 9 will be made. The speech waveform generation unit 353 generates a speech waveform by inputting the acoustic feature value of the acoustic feature value table 342 to the speech waveform generation model M2.

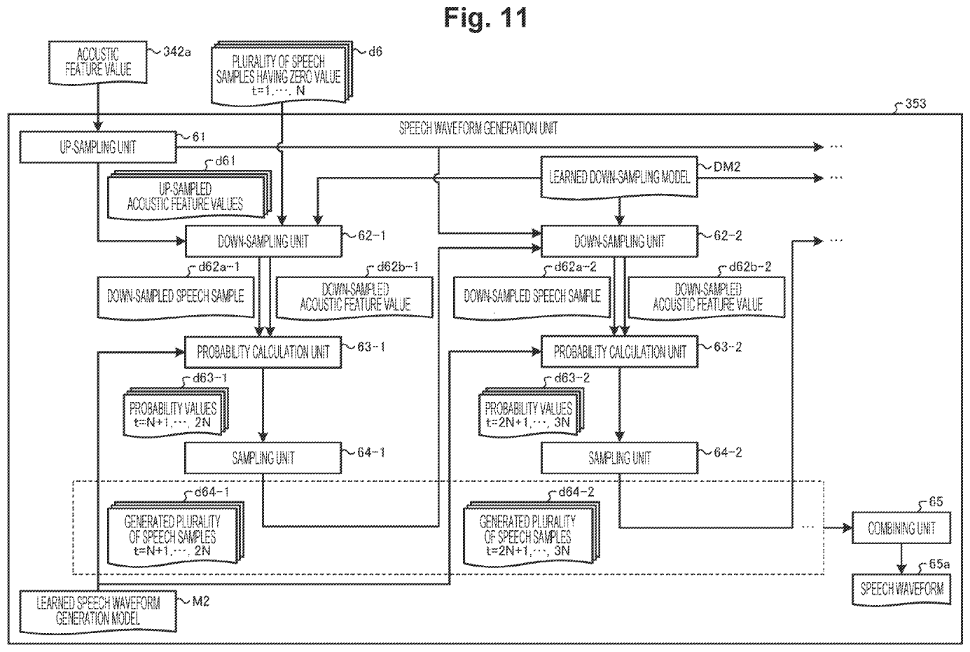

FIG. 11 is a diagram illustrating a configuration of a speech waveform generation unit according to Example 3. As illustrated in FIG. 11, the speech waveform generation unit 353 includes an up-sampling unit 61, down-sampling units 62-1, 62-2, . . . , probability calculation units 63-1, 63-2, . . . , sampling units 64-1, 64-2, . . . , and a combining unit 65.

The speech waveform generation unit 353 reads an acoustic feature value 342a from the acoustic feature value table 242 of FIG. 9. In addition, it is assumed that the speech waveform generation unit 353 has information on the speech waveform generation model M2 and information on the sampling model DM2 learned by the learning unit 352. In addition, it is assumed that the speech waveform generation unit 353 has a plurality of speech samples d6 having a zero value. The plurality of speech samples d6 having a zero value is a speech sample in which the values of the speech waveform corresponding to the times t=1, . . . N are all zero.

The up-sampling unit 61 extends a sequence length of the acoustic feature value 342a so that the sequence length is the same as the number of speech samples, thereby generating up-sampled acoustic feature values d61. The up-sampling unit 61 outputs the acoustic feature value d61 to the down-sampling units 62-1, 62-2, . . . . The up-sampling executed by the up-sampling unit 61 is similar to the up-sampling executed by the up-sampling unit 11 described above.

The down-sampling unit 62-1 inputs the plurality of speech samples d6 and the acoustic feature values d61 to the down-sampling model DM2, thereby generating a down-sampled speech sample d62a-1 and a down-sampled acoustic feature value 62b-1. The down-sampling unit 62-1 outputs the speech sample d62a-1 and the acoustic feature value 62b-1 to the probability calculation unit 63-1.

The probability calculation unit 63-1 inputs the acoustic feature value d62b-1 and the speech sample d62a-1 to the speech waveform generation model M2, thereby calculating probability values d63-1 (regarding the amplitude of the speech waveform) at the times t=N+1, . . . , 2N. The probability calculation unit 63-1 outputs the probability values d63-1 to the sampling unit 64-1. Other descriptions of the probability calculation unit 63-1 are similar to those of the probability calculation unit 13-1 described in Example 1.

The sampling unit 64-1 outputs values according to a specific distribution depending on the probability values d63-1, thereby generating a plurality of speech samples d64-1 at the times t=N+1, . . . 2N. The sampling unit 64-1 outputs the plurality of speech samples d64-1 to the down-sampling unit 62-2.

The down-sampling unit 62-2 inputs the acoustic feature values d61 and the plurality of speech samples d64-1 to the down-sampling model DM3, thereby generating a down-sampled speech sample d62a-2 and a down-sampled acoustic feature value 62b-2. The down-sampling unit 62-2 outputs the speech sample d62a-2 and the acoustic feature value 62b-2 to the probability calculation unit 63-2.

The probability calculation unit 63-2 inputs the acoustic feature value 62b-2 and the speech sample 62a-2 to the speech waveform generation model M2, thereby calculating probability values d63-2 (regarding the amplitude of the speech waveform) at the times t=2N+1, . . . 3N. The probability calculation unit 63-2 outputs the probability values d63-2 to the sampling unit 64-2. Other processing regarding the probability calculation unit 63-2 is similar to the processing executed by the probability calculation unit 13-2.

The sampling unit 64-2 outputs values according to a specific distribution depending on the probability values d63-2, thereby generating a plurality of speech samples d64-2 at the times t=2N+1, . . . 3N. The description of other processing executed by the sampling unit 54-2 is similar to the description of the processing executed by the sampling unit 14-2.

The sampling unit 64-2 outputs the plurality of speech samples d64-2 to the down-sampling unit 62-3 (not illustrated). Thereafter, the down-sampling units 62-3, the probability calculation units 63-3, . . . , and the sampling units 64-3, . . . (not illustrated) each execute processing, thereby generating probability values d63-3 to d63-M and a plurality of speech samples d64-3 to d64-M.

The combining unit 65 generates a speech waveform 65a by connecting the plurality of speech samples d64-1 to d64-M together.

Next, effects of the generation device 300 according to Example 3 will be described. The learning unit 352 of the generation device 300 does not perform execution only on speech samples but learns a down-sampling model in consideration of phonological and rhythmic information represented by acoustic feature values. By using such a down-sampling model, it is possible to learn a speech waveform generation model by performing down-sampling based on the acoustic feature values and the speech samples, which leads to improvement in quality of the speech waveform.

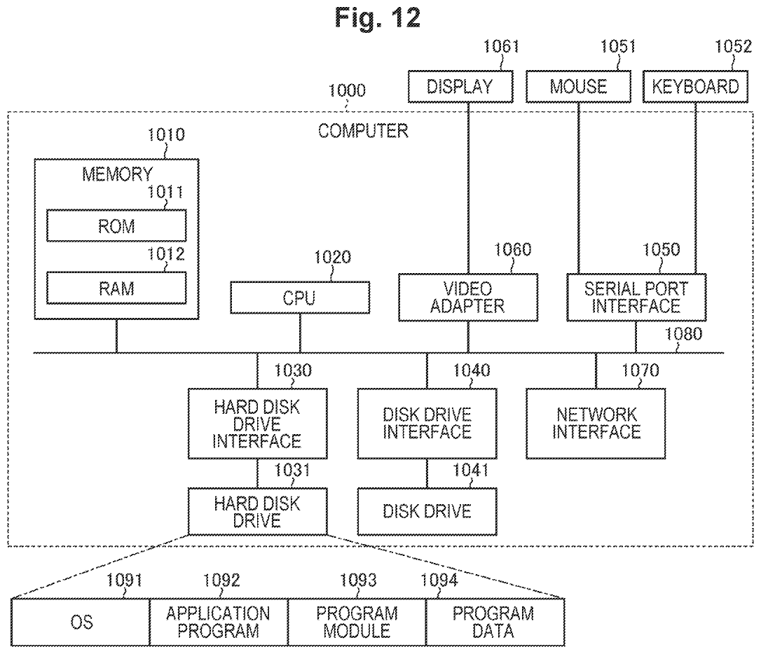

FIG. 12 is a diagram illustrating an example of a computer that executes a generation program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disk is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

In addition, the generation program is stored in the hard disk drive 1031 as the program module 1093 in which commands to be executed by the computer 1000, for example, are described. Specifically, the program module 1093 in which each piece of the processing executed by the generation device 100 described in the above embodiment is described is stored in the hard disk drive 1031.

In addition, data used for information processing performed by the generation program is stored as the program data 1094 in the hard disk drive 1031, for example. Then, the CPU 1020 reads, in the RAM 1012, the program module 1093 and the program data 1094 stored in the hard disk drive 1031 as needed and executes each procedure described above.

Note that the program module 1093 and the program data 1094 related to the generation program are not limited to being stored in the hard disk drive 1031, and may be stored in, for example, a removable storage medium and read by the CPU 1020 via a disk drive 1041 or the like. Alternatively, the program module 1093 and the program data 1094 related to the generation program may be stored in another computer connected via a network such as LAN or a wide area network (WAN), and may be read by the CPU 1020 via the network interface 1070.

Although the embodiment to which the invention made by the present inventor is applied has been described above, the present invention is not limited by the description and drawings constituting a part of the disclosure of the present invention according to the present embodiment. In other words, other embodiments, examples, operation techniques, and the like made by those skilled in the art and the like on the basis of the present embodiment are all included in the scope of the present invention.

### REFERENCE SIGNS LIST

100, 200, 300 generation device
110, 210, 310 communication control unit
120, 220, 320 input unit
130, 230, 330 output unit
140, 240, 340 storage unit
141, 241, 341 speech waveform table
142, 242, 342 acoustic feature value table
150, 250, 350 control unit
151, 251, 351 acquisition unit
152, 252, 352 learning unit
153, 253, 353 speech waveform generation unit

1. A generation method comprising:
extracting a plurality of integrated speech samples, wherein the extracting the plurality of integrated speech samples comprises iteratively performing:
integrating a plurality of consecutive speech samples extracted from speech waveform information into one speech sample, and
compressing the plurality of integrated speech samples in the one speech sample to generate a compressed speech sample; and
generating a plurality of new integrated speech samples subsequent to the plurality of integrated speech samples, wherein the generating the plurality of new integrated speech samples comprises iteratively performing:
inputting the compressed speech sample and an acoustic feature value calculated from the speech waveform information to a speech waveform generation model, and
compressing the plurality of new integrated speech samples and the acoustic feature value to the speech waveform generation model.

2. The generation method according to claim 1, wherein the speech waveform generation model outputs a probability value associated with an amplitude of a speech waveform at each of times based on the compressed speech sample and the acoustic feature value as input to the speech waveform generation model, and the generating further comprises generating the plurality of new integrated speech samples based on the probability value associated with the amplitude of the speech waveform at each of the times.

3. The generation method according to claim 2, wherein the generating further comprises learning the speech waveform generation model based on a loss value between the probability value and the speech waveform information.

4. The generation method according to claim 3, further comprising:
iteratively processing:
generating a plurality of new integrated speech samples by inputting a combination including the compressed speech sample and a specified acoustic feature value to a learning model; and
combining the plurality of integrated speech samples.

5. The generation method according to claim 3, further comprising:
learning a down-sampling model, wherein the down-sampling model outputs the compressed speech sample based on the loss value according to the plurality of integrated speech samples as input.

6. The generation method according to claim 3, further comprising:
learning a down-sampling model, wherein the down-sampling model outputs the compressed speech sample and a down-sampled acoustic feature value based on the loss value according to the plurality of integrated speech samples and the acoustic feature value as input.

7. A generation device comprising a processor configured to execute operations comprising:
extracting a plurality of integrated speech samples, wherein the extracting the plurality of integrated speech samples comprises iteratively performing:
integrating a plurality of consecutive speech samples included in speech waveform information into one speech sample, and
generating a compressed speech sample by compressing the plurality of integrated speech samples to generate a compressed speech sample; and
generating a plurality of new integrated speech samples subsequent to the plurality of integrated speech samples, wherein the generating the plurality of new integrated speech samples comprises iteratively performing:
inputting the compressed speech sample and an acoustic feature value calculated from the speech waveform information to a speech waveform generation model, and
compressing the plurality of new integrated speech samples and the acoustic feature value to the speech waveform generation model.

8. A computer-readable non-transitory recording medium storing computer-executable program instructions that when executed by a processor cause a computer system to execute operations comprising:
extracting a plurality of integrated speech samples, wherein the extracting the plurality of integrated speech samples comprises iteratively performing:
integrating a plurality of consecutive speech samples included in speech waveform information into one speech sample, and
generating a compressed speech sample by compressing the plurality of integrated speech samples to generate a compressed speech sample; and
generating a plurality of new integrated speech samples subsequent to the plurality of integrated speech samples, wherein the generating the plurality of new integrated speech samples comprises iteratively performing:
inputting the compressed speech sample and an acoustic feature value calculated from the speech waveform information to a speech waveform generation model, and
compressing the plurality of new integrated speech samples and the acoustic feature value to the speech waveform generation model.

9. The generation device according to claim 7, wherein the speech waveform generation model outputs a probability value associated with an amplitude of a speech waveform at each of times based on the compressed speech sample and the acoustic feature value as input to the speech waveform generation model, and the generating further comprises generating the plurality of new integrated speech samples based on the probability value associated with the amplitude of the speech waveform at each of the times.

10. The generation device according to claim 9, wherein the generating further comprises learning the speech waveform generation model based on a loss value between the probability value and the speech waveform information.

11. The generation device according to claim 10, the processor further configured to execute operations comprising:
iteratively processing:
generating a plurality of new integrated speech samples by inputting a combination including the compressed speech sample and a specified acoustic feature value to a learning model; and
combining the plurality of integrated speech samples.

12. The generation device according to claim 10, the processor further configured to execute operations comprising:
learning a down-sampling model, wherein the down-sampling model outputs the compressed speech sample based on the loss value according to the plurality of integrated speech samples as input.

13. The generation device according to claim 10, the processor further configured to execute operations comprising:
learning a down-sampling model, wherein the down-sampling model outputs the compressed speech sample and a down-sampled acoustic feature value based on the loss value according to the plurality of integrated speech samples and the acoustic feature value as input.

14. The computer-readable non-transitory recording medium according to claim 8, wherein the speech waveform generation model outputs a probability value associated with an amplitude of a speech waveform at each of times based on the compressed speech sample and the acoustic feature value as input to the speech waveform generation model, and the generating further comprises generating the plurality of new integrated speech samples based on the probability value associated with the amplitude of the speech waveform at each of the times.

15. The computer-readable non-transitory recording medium according to claim 14, wherein the generating further comprises learning the speech waveform generation model based on a loss value between the probability value and the speech waveform information.

16. The computer-readable non-transitory recording medium according to claim 15, the computer-executable program instructions when executed further causing the computer system to execute operations comprising:
iteratively processing:
generating a plurality of new integrated speech samples by inputting a combination including the compressed speech sample and a specified acoustic feature value to a learning model; and
combining the plurality of integrated speech samples.

17. The computer-readable non-transitory recording medium according to claim 15, the computer-executable program instructions when executed further causing the computer system to execute operations comprising:
learning a down-sampling model, wherein the down-sampling model outputs the compressed speech sample based on the loss value according to the plurality of integrated speech samples as input.

18. The computer-readable non-transitory recording medium according to claim 15, the computer-executable program instructions when executed further causing the computer system to execute operations comprising:
learning a down-sampling model, wherein the down-sampling model outputs the compressed speech sample and a down-sampled acoustic feature value based on the loss value according to the plurality of integrated speech samples and the acoustic feature value as input.
